(19) United States
(12) Patent Application Publication
(10) Pub. No.: US 2007/0041219 A1
(43) Pub. Date: Feb. 22, 2007

(54) Lamp clip, backlight assembly and display device having the same

(76) Inventors: Jun-Woo You, Gyeonggi-do (KR); Dong-Choul Yang, Gyeonggi-do (KR); Seung-Je Lee, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/505,557

(22) Filed: Aug. 16, 2006

(30) Foreign Application Priority Data
Aug. 16, 2005 (KR) 2005-74765

(51) Int. Cl. F21V 21/00

(52) U.S. Cl. 362/634; 362/225; 362/396; 362/613

(57) ABSTRACT

A backlight assembly with enhanced reliability is presented. The backlight assembly includes a plurality of lamps, a lamp clip and a shrink tube. The lamps generate light, and each of the lamps includes a first electrode and a second electrode. The lamp clip includes a body and a connecting portion. The body has a plurality of through-holes into which a portion of first electrodes of adjacent lamps is inserted. The connecting portion extends from an end portion of the body to be electrically connected to a lamp wire, wherein the lamp wire transmits a voltage to the portion of the first electrodes of the adjacent lamps. The shrink tube covers the lamp wire and the connecting portion. The shrink tube covers the connecting portion between the lamp clip and the lamp wire to prevent their separation even upon receiving an impact.

### CROSS-REFERENCE TO RELATED APPLICATIONS

This application relies for priority upon Korean Patent Application No. 2005-74765 filed on Aug. 16, 2005, the content of which is herein incorporated by reference in its entirety.

### BACKGROUND OF THE INVENTION

1. Field of the Invention

The present invention relates generally to a lamp clip usable with a light assembly and particularly to a lamp clip capable of improving reliability the reliability of a light assembly.

2. Description of the Related Art

A liquid crystal display (LCD) device includes an array substrate, a color filter substrate and a liquid crystal layer between the two substrates. The array substrate includes a thin-film transistor. The liquid crystal layer has a dielectric liquid crystal material having an anisotropic dielectric constant. The liquid crystals vary their arrangement in response to an electric field applied thereto. Thus, the desired image is displayed by controlling light transmittance through the liquid crystal layer by varying the electric field applied to the liquid crystals.

The LCD device, in general, includes a backlight assembly generating light, an LCD panel displaying images using the light, and a receiving container that receives the backlight assembly and the LCD panel.

The backlight assembly includes a plurality of lamps generating light. Each of the lamps includes a hot electrode and a cold electrode on the end portions of the lamps. Lamp wires are soldered on the hot and cold electrodes.

A problem with the solder points is that they can be a source of defect or breakage. Each of the soldered portions between a hot electrode and a lamp wire and between a cold electrode and a lamp wire is vulnerable to breakage upon receiving an external impact. When one of the soldered portions is broken, the voltage is not properly applied to each of the hot and cold electrodes. As a result, the reliability of the backlight assembly is compromised.

### SUMMARY OF THE INVENTION

The present invention provides a lamp clip capable of improving the reliability of a backlight assembly. The present invention also provides a backlight assembly having the above-mentioned lamp clip. The present invention also provides a display device having the above-mentioned backlight assembly.

In one aspect, the invention is a lamp clip that includes a body and a connecting portion. The body has a plurality of through-holes capable of receiving a plurality of lamp electrodes. The connecting portion extends from an end portion of the body to be electrically connected to a lamp wire, wherein the lamp wire transmits a voltage to the lamps.

In another aspect, the invention is a backlight assembly. The backlight assembly includes a plurality of lamps, a lamp clip and a shrink tube. The lamps generate light, and each of the lamps includes a first electrode and a second electrode. The lamp clip includes a body and a connecting portion. The body has a plurality of through-holes into which a portion of first electrodes of adjacent lamps is inserted. The connecting portion extends from an end portion of the body to be electrically connected to a lamp wire, wherein the lamp wire transmits a voltage to the portion of the first electrodes of the adjacent lamps. The shrink tube covers the lamp wire and the connecting portion.

In yet another aspect, the invention is a display device that includes a display panel that displays an image and the above backlight assembly.

According to the lamp clip, the backlight assembly and the display device of the present invention, the shrink tube covers the connecting portion between the lamp clip and the lamp wire to reinforce the connection between the lamp electrode and the lamp wire. Therefore, the overall reliability of the device may be improved without significantly increasing manufacturing cost.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective illustrating a backlight assembly in accordance with one embodiment of the present invention;

FIG. 2 is a perspective view illustrating a lamp assembly shown in FIG. 1;

FIG. 3 is a perspective view illustrating a second lamp holder shown in FIG. 2;

FIG. 4 is a plan view illustrating cold electrodes of first and second lamps shown in FIG. 2;

FIG. 5 is a plan view illustrating a lamp clip shown in FIG. 4; and

FIG. 6 is an exploded perspective view illustrating a display device in accordance with one embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-sectional illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

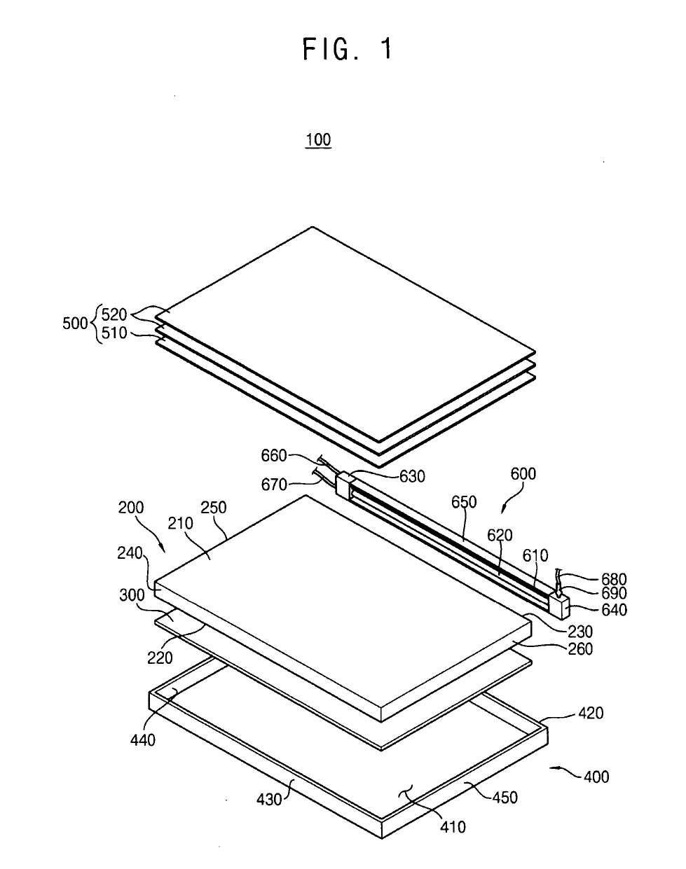

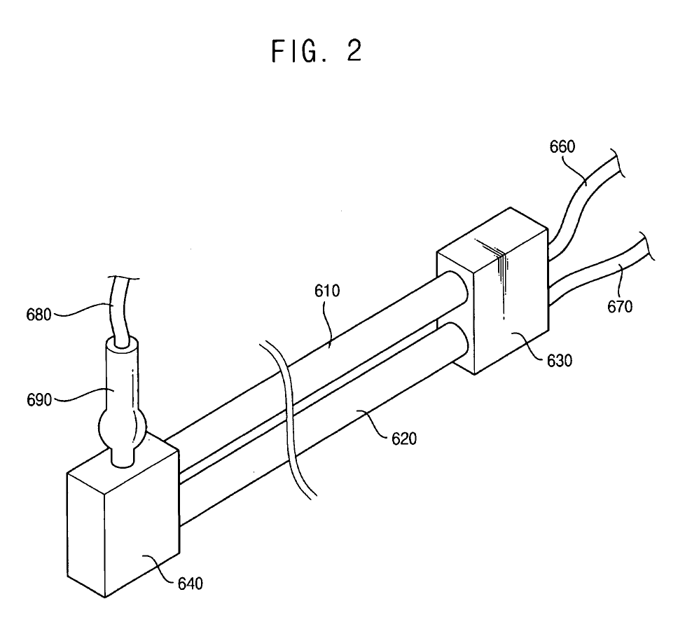

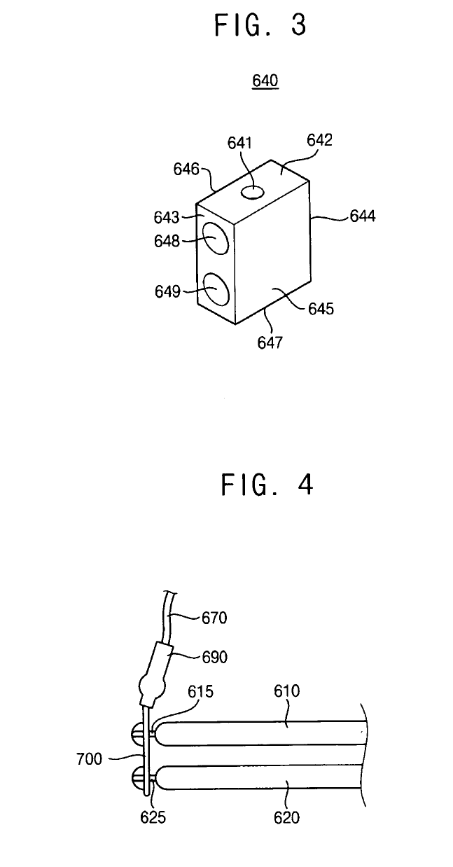

FIG. 1 is an exploded perspective illustrating a backlight assembly in accordance with one embodiment of the present invention. FIG. 2 is a perspective view illustrating a lamp assembly shown in FIG. 1. FIG. 3 is a perspective view illustrating a second lamp holder shown in FIG. 2.

Referring to FIGS. 1 to 3, the backlight assembly 100 includes a light-guiding plate 200, a reflective sheet 300, a receiving container 400, optical sheets 500 and a lamp assembly 600.

The light-guiding plate 200 may have a substantially rectangular shape, and may include a transparent resin. Examples of the transparent resin that can be used for the light-guiding plate 200 include acryl, polycarbonate (PC), polymethyl methacrylate (PMMA), etc. The light-guiding plate 200 includes a side surface member that includes a first side surface 230, a second side surface 240, a third side surface 250 and a fourth side surface 260. In addition, the light-guiding plate 200 has a light-exiting surface 210 and a light-reflecting surface 220. The light-exiting surface 210 extends from an edge of the side surface member. The light-reflecting surface 220 extends from an opposite edge of the side surface member.

In FIGS. 1 to 3, the first side surface 230 is in a plane parallel to the plane of the second side surface 240, and the third side surface 250 is in a plane parallel to the plane of the fourth side surface 260. Therefore, the first side surface 230 extends between first edges of the third and fourth side surfaces 250 and 260, and the second side surface 240 extends between second edges of the third and fourth side surfaces 250 and 260. The first side surface 230 is a light-incident surface that is adjacent to the lamp assembly 600 to receive light generated from the lamp assembly 600.

The light-guiding plate 200 may have a substantially rectangular plate shape. Alternatively, the light-guiding plate 200 may have a wedge shape. If the light-guiding plate 200 has a wedge shape, the thickness of the light-guiding plate 200 decreases as a function of distance from one end of the second surface 240 along the length of the second surface 240.

The light-exiting surface 210 is in a plane parallel to the plane of the light-reflecting surface 220. Some of the light that is incident on the light-guiding plate 200 through the first side surface 230 exits the light-exiting surface 210. The rest of the light that is incident on the light-guiding plate 200 through the first side surface 230 is reflected by the light-reflecting surface 220.

A plurality of prism patterns (not shown) may be formed on the light-exiting surface 210 or the light-reflecting surface 220 to change the path of the light generated by the lamp assembly 600. When a groove or a protrusion is formed on the first, second, third and fourth side surfaces 230, 240, 250 and 260, luminance and luminance uniformity may be adversely affected. Therefore, it is preferable that no groove or the protrusion be formed on the first, second, third and fourth side surfaces 230, 240, 250 and 260.

The reflective sheet 300 is disposed under the light-guiding plate 200. The light that leaks from the light-guiding plate 200 through the light-reflecting surface 220 is reflected by the reflective sheet 300 toward the light-guiding plate 200. The reflective sheet 300 may include a reflective material for reflecting the light that leaked from the light-guiding plate 200 through the light-reflecting surface 220. In some embodiments, a reflective material is coated on a base film to form the reflective sheet 300.

The receiving container 400 includes a bottom plate 410, a first sidewall 420, a second sidewall 430, a third sidewall 440 and a fourth sidewall 450. The first, second, third and fourth sidewalls 420, 430, 440 and 450 protrude from the edges of the bottom plate 410 to define a receiving space. The reflective sheet 300, the lamp assembly 600 and the light-guiding plate 200 are received in the receiving space.

The optical sheets 500 include a diffusion sheet 510 and a prism sheet 520. The diffusion sheet 510 is disposed on the light-guiding plate 200 to diffuse the light exiting the light-guiding plate 200 through the light-exiting surface 210, thereby increasing the luminance uniformity. In addition, the prism sheet 520 is disposed on the diffusion sheet 510 to receive the light having passed through the diffusion sheet 510, thereby enhancing the luminance.

The lamp assembly 600 includes a first lamp 610, a second lamp 620, a first lamp holder 630 and a second lamp holder 640. The lamp assembly 600 may further include a lamp reflecting plate 650 to protect the first and second lamps 610 and 620. In addition, the light generated from the first and second lamps 610 and 620 is reflected by the lamp reflecting plate 650 toward the light-guiding plate 200. The lamp assembly 600 is received in the receiving container 400 adjacent to the first side 420 of the receiving container 400.

Each of the first and second lamps 610 and 620 may be a cold cathode fluorescent lamp (CCFL) that has a rod shape. Each of the first and second lamps 610 and 620 includes a hot electrode (not shown) that receives a high voltage. The hot electrode (not shown) may be adjacent to an end portion of each of the first and second lamps 610 and 620. In addition, each of the first and second lamps 610 and 620 includes a cold electrode (not shown) that receives a low voltage. The cold electrode (not shown) may be adjacent to an end portion of each of the first and second lamps 610 and 620 that is the opposite end of where the hot electrode is. In an alternative embodiment, each of the first and second lamps 610 and 620 may have an external electrode fluorescent lamp (EEFL) having hot and cold electrodes on an external surface of the EEFL.

The first lamp holder 630 may cover the hot electrodes of the first and second lamps 610 and 620. The second lamp holder 640 may cover the cold electrodes of the first and second lamps 610 and 620. The second lamp holder 640 includes a body and a first receiving hole 641 for receiving a third power supply line that is a third lamp wire 680. As shown in FIG. 3, the body of the second lamp holder 640 may have a substantially rectangular parallelepiped shape. The body of the second lamp holder 640 includes a first surface 642, a second surface 643, a third surface 644, a fourth surface 645, a fifth surface 646 and a sixth surface 647. The first receiving hole 641 may be on the first surface 642. A second receiving hole 648 and a third receiving hole 649 may be formed on the second surface 643 for receiving the cold electrodes of the first and second lamps 610 and 620.

The lamp reflecting plate 650 may include a highly reflective material. In some embodiments, a highly reflective material is coated on a cover surface of a plate to form the lamp reflecting plate 650. The cover surface of the lamp reflecting plate 650 covers the first and second lamps 610 and 620. The light generated from the first and second lamps 610 and 620 is reflected from the lamp reflecting plate 650 toward the light-guiding plate 200 to increase luminance.

The lamp assembly 600 may further include a first power supply line that is a first lamp wire 660, a second power supply line that is a second lamp wire 670, the third power supply line that is the third lamp wire 680, and a shrink tube 690. A high voltage is applied to the hot electrode of the first lamp 610 through the first lamp wire 660. A high voltage is also applied to the hot electrode of the second lamp 620 through the second lamp wire 670. A low voltage is applied to the cold electrodes of the first and second lamps 610 and 620 through the third lamp wire 680.

The cold electrodes of the first and second lamps 610 and 620 are electrically connected to each other.

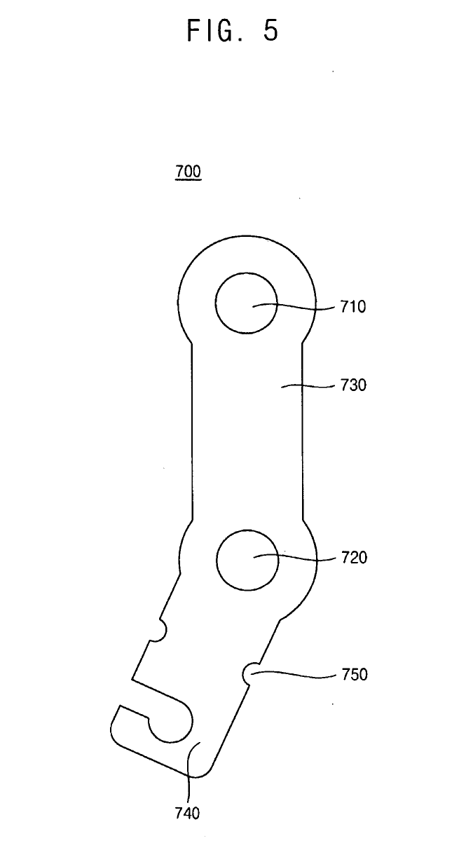

FIG. 4 is a plan view illustrating the cold electrodes of first and second lamps shown in FIG. 2. FIG. 5 is a plan view illustrating a lamp clip shown in FIG. 4.

Referring to FIGS. 4 and 5, a first cold electrode 615 of the first lamp 610 is electrically connected to a second cold electrode 625 of the second lamp. The first and second cold electrodes 615 and 625 are electrically connected to each other through a lamp clip 700. The lamp clip 700 includes a body 730 and a connecting portion 740. The body 730 of the lamp clip 700 includes a first through-hole 710 and a second through-hole 720. The connecting portion 740 is extended from an end portion of the body 730 of the lamp clip 700, in a direction forming a predetermined angle with respect to a longitudinal direction of the body 730 of the lamp clip 700.

The lamp clip 700 includes a conductive material. The first cold electrode 615 of the first lamp 610 is inserted into the first through-hole 710 of the lamp clip 700. The second cold electrode 625 of the second lamp 620 is inserted into the second through-hole 720 of the lamp clip 700. The first cold electrode 615 inserted into the first through-hole 710 and the second cold electrode 625 inserted into the second through-hole 720 are soldered so that the first and second cold electrodes 615 and 625 are electrically connected to each other through the lamp clip 700.

The connecting portion 740 of the lamp clip 700 has a ring shape with an opening portion. The third lamp wire 680 is electrically connected to the connecting portion 740, and is soldered onto the connecting portion 740. The low voltage is applied to the first and second cold electrodes 615 and 625 through the third lamp wire 680.

The connecting portion 740 of the lamp clip 700 is covered by the shrink tube 690. The shrink tube 690 covers the soldered connecting portion 740 and the soldered third lamp wire 680. The shrink tube 690 may be made of an elastic material. The shrink tube 690 prevents separation of the soldered connecting portion 740 from the soldered lamp wire 680. The shrink tube may include a protecting tube, a retracting tube, a tensile tube, a flexible tube, a rubber tube, etc.

In addition, a holding recess 750 may be formed on the lamp clip 700 between the connecting portion 740 and the first and second through-holes 710 and 720. A plurality of the holding recesses 750 may be formed on the lamp clip 700. A portion of the body 730 of the lamp clip 700 adjacent to an end portion of the lamp clip 700 may be removed to form the holding recess 750. Therefore, the shrink tube 690 is caught in the holding recess 750 to prevent separation of the shrink tube 690 from the lamp clip 700.

In FIGS. 4 and 5, the first cold electrode 615 of the first lamp 610 is electrically connected to the second cold electrode 625 of the second lamp 620 through the lamp clip 700. Depending on the embodiment, the number of the cold electrodes electrically connected to the lamp clip may be changed. The number of the through-holes in the lamp clip 700 is substantially the same as the number of lamps.

According to the backlight assembly 100 shown in FIGS. 1 to 5, the lamp clip 700 includes the connecting portion 740 to facilitate the connection between the shrink tube 690 and the lamp clip 700. The soldered third lamp wire 680 is covered by the shrink tube 690 to prevent separation of the third lamp wire 680 from the lamp clip 700. Therefore, low voltage may be constantly applied to the cold electrode through the third lamp wire 680, thereby increasing the reliability of the backlight assembly 100.

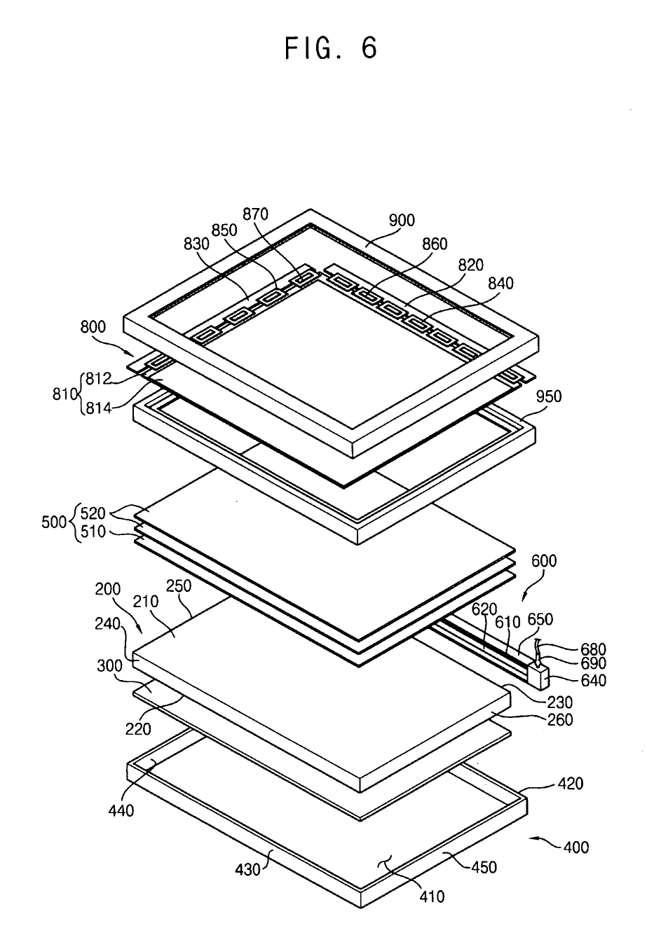

FIG. 6 is an exploded perspective view illustrating a display device in accordance with one embodiment of the present invention.

Referring to FIG. 6, the display device includes a backlight assembly and a display unit 800.

The backlight assembly of FIG. 6 is substantially the same as in FIGS. 1 to 4. Thus, the same reference numerals will be used to refer to the same or like parts as those described in FIGS. 1 to 4 and any redundant explanation concerning the above elements will be omitted.

The display unit 800 includes a liquid crystal display (LCD) panel 810, a source printed circuit board (source PCB) 820 and a gate printed circuit board (gate PCB) 830. The LCD panel 810 displays an image. The source and gate printed circuit boards 820 and 830 apply driving signals to the LCD panel 810 to drive the LCD panel 810.

The driving signals that are from the source PCB 820 and the gate PCB 830 are applied to the LCD panel 810 through a data flexible circuit film 840 and a gate flexible circuit film 850. Each of the data and gate flexible circuit film 840 and 850 may include a tape carrier package (TCP), a chip-on-film (COF), etc.

The data and gate flexible circuit films 840 and 850 may further include a data driving chip 860 and a gate driving chip 870, respectively. The data and gate driving chips 860 and 870 control the timing of application of the driving signals from the source PCB 820 and the gate PCB 830 to the LCD panel 810, respectively.

The LCD panel 810 includes a thin-film transistor (TFT) substrate 812, a color filter substrate 814 and a liquid crystal layer (not shown). The color filter substrate 814 is combined with the TFT substrate 812. The liquid crystal layer (not shown) is interposed between the TFT substrate 812 and the color filter substrate 814.

In FIG. 6, the TFT substrate 812 is a glass substrate having a plurality of TFTs (not shown) arranged in a matrix. Each of the TFTs (not shown) is a switching element. The source electrode of each of the TFTs is electrically connected to a data line. The gate electrode of each of the TFTs is electrically connected to a gate line. The drain electrode of each of the TFTs is electrically connected to a pixel electrode. The pixel electrode includes a transparent conductive material. General layout of TFT substrate is well known.

The color filter substrate 814 is spaced apart from the TFT substrate 812 by a constant distance, and is in a plane parallel to the plane of the TFT substrate 812. The color filter substrate 814 includes a plurality of red, green and blue color filters. Each of the red, green and blue color filters transmits light having a predetermined wavelength. The red, green and blue color filters may be formed through a photo process. A common electrode is formed on an entire surface of the color filter substrate 814.

When a voltage is applied to the gate electrode of each of the TFTs of the LCD panel 810, the TFT is turned on so that an electric field is formed between the pixel electrode and the common electrode. Liquid crystals of the liquid crystal layer (not shown) between the TFT substrate 812 and the color filter substrate 814 vary their arrangement in response to the electric field applied thereto. Thus, light transmittance through the liquid crystal layer is changed by adjusting the electric field. The light transmittance is changed to select the proper gray-scale of the light generated from the backlight assembly, thereby displaying the desired image.

The source PCB 820 is electrically connected to an end portion of the TFT substrate 812 through the data flexible circuit film 840. In addition, the gate PCB 830 is electrically connected to another end portion of the TFT substrate 812 through the gate flexible circuit film 850. Therefore, the driving signals including a data driving signal generated from the source PCB 820 and a gate driving signal generated from the gate PCB 830 are applied to the LCD panel 810.

The data driving signal controls the data line that is formed on the TFT substrate 812. The data driving signal is applied to the data line through the data flexible circuit film 840. The gate driving signal controls the gate line that is formed on the TFT substrate 812. The gate driving signal is applied to the gate line through the gate flexible circuit film 850. A conductive line (not shown) may be formed on the TFT substrate 812 so that the data flexible circuit film 840 is electrically connected to the gate flexible circuit film 850.

The display unit 800 is mounted on the backlight assembly. The LCD panel 810 is received in an upper mold frame 950, and the upper mold frame 950 is placed on the backlight assembly. In addition, the data flexible circuit film 840 is bent toward a rear surface of the receiving container 400 so that the source PCB 820 is fixed to the rear surface of the receiving container 400. The “rear” surface is the surface that is at the bottom when described in reference to FIG. 6.

The top chassis 900 surrounds the sides of the LCD panel 810 that is disposed on the backlight assembly so that the top chassis 900 is combined with the receiving container 400. The top chassis 900 protects the LCD panel 810 from external impacts, and prevents separation of the LCD panel 810.

In FIGS. 1 to 6, the LCD device includes the backlight assembly. The backlight assembly may be used for various display devices.

According to the present invention as detailed above, the lamp clip includes the connecting portion to which the lamp wire that is used for applying the low voltage to the cold electrode is connected. Because the shrink tube easily covers the connecting portion that combines the lamp clip and the lamp wire, the connection between the electrodes and the lamp wires is easily reinforced.

Therefore, the shrink tube easily covers the connecting portion between the lamp clip and the lamp wire to prevent the separation of the connecting portion, thereby improving the reliability of the display device.

Although the embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. A lamp clip comprising:
a body having a plurality of through-holes capable of receiving a plurality of lamp electrodes; and
a connecting portion extending from an end portion of the body to be electrically connected to a lamp wire, wherein the lamp wire transmits a voltage to the lamps.

2. The lamp clip of claim 1, wherein the connecting portion has a substantially ring shape with an opening portion.

3. The lamp clip of claim 1, wherein the body and the connecting portion comprise a conductive material.

4. The lamp clip of claim 1, wherein each of the electrodes comprises a cold electrode.

5. The lamp clip of claim 1, wherein a holding recess is formed on the body to hold a shrink tube that covers the lamp wire and the connecting portion.

6. A backlight assembly comprising:
a plurality of lamps generating light, each of the lamps including a first electrode and a second electrode;
a lamp clip including:
a body having a plurality of through-holes into which first electrodes of adjacent lamps is inserted; and
a connecting portion extending from an end portion of the body to be electrically connected to a lamp wire, wherein the lamp wire transmits a voltage to the portion of the first electrodes of the adjacent lamps; and
a shrink tube that covers the lamp wire and the connecting portion.

7. The backlight assembly of claim 6, wherein the lamp clip comprises a conductive material.

8. The backlight assembly of claim 6, wherein a holding recess is formed on the body to hold the shrink tube.

9. The backlight assembly of claim 6, wherein the connecting portion has a substantially ring shape with an opening portion.

10. The backlight assembly of claim 6, wherein the first electrode is a cold electrode and the second electrode is a hot electrode.

11. The backlight assembly of claim 6, wherein the backlight assembly further comprises:
a first lamp holder including a receiving hole to hold the first electrode, the lamp wire being inserted into the receiving hole; and
a second lamp holder that holds the second electrode.

12. A display device comprising:
a display panel that displays an image; and
a backlight assembly supplying the display panel with light to display the image, the backlight assembly including:
a plurality of lamps generating the light, each of the lamps including a first electrode and a second electrode;
a lamp clip including:
a body having a plurality of through-holes into which a portion of first electrodes of adjacent lamps is inserted; and
a connecting portion extending from an end portion of the body to be electrically connected to a lamp wire, the lamp wire transmitting a voltage to the portion of the first electrodes of the adjacent lamps; and
a shrink tube that covers the lamp wire and the connecting portion.

13. The display device of claim 12, wherein the lamp clip comprises a conductive material.

14. The display device of claim 12, wherein a holding recess is formed on the body to hold the shrink tube.

15. The display device of claim 12, wherein the connecting portion has a substantially ring shape with an opening portion.

16. The display device of claim 12, wherein the first electrode is a cold electrode, and the second electrode is a hot electrode.
